(19) United States
(12) Patent Application Publication
(10) Pub. No.: US 2010/0055496 A1
(43) Pub. Date: Mar. 4, 2010

(54) STEEL HAVING HIGH STRENGTH

(75) Inventors: Hee Won JUNG, Hwasung-si (KR); Young June PARK, Hwasung-si (KR); Dong Sam KIM, Hwasung-si (KR); Dong Nyung LEE, Seoul (KR); Kyu Hwan OH, Seoul (KR); Yinzhong SHEN, Daejeon (KR); Sung Chul Kim, Hwasung-si (KR)

Correspondence Address: Jason Y. Pahng and Associates, LLC, 12178 Bridgend Run, Fairfax, VA, 22030, US

(73) Assignee: ILJIN LIGHT METAL CO., LTD., Anyang-city (KR)

(21) Appl. No.: 12/613,463

(22) Filed: Nov. 5, 2009

Related U.S. Application Data
(63) Continuation-in-part of application No. 11/588,370, filed on Oct. 27, 2006.

(30) Foreign Application Priority Data
Feb. 23, 2006 (KR) 10-2006-0017894
May 30, 2006 (KR) 10-2006-0049077
Nov. 7, 2008 (KR) 10-2008-00110498

(51) Int. Cl. B32B 15/01

(52) U.S. Cl. 428/683

(57) ABSTRACT

A steel having an improved tensile strength includes a first layer formed of an ultra-low carbon steel; and a second layer that is formed in contact with the first layer, includes a first surface opposite to the first layer, is formed of a solid solution obtained by solid-solving nitrogen in the ultra-low carbon steel, and has a structure substantially the same as a structure of the first layer.

### CROSS-REFERENCE TO RELATED PATENT APPLICATION

This application is a continuation in part of application Ser. No. 11/588,370, filed on Oct. 27, 2006, which claims the benefits of Korean Patent Application Nos. 10-2006-0017894, filed on Feb. 23, 2006, and 10-2006-0049077, filed on May 30, 2006 in the Korean Intellectual Property Office, and the benefit of Korean Patent Application No. 10-2008-00110498, filed on Nov. 7, 2008 in the Korean Intellectual Property Office, the disclosures of which are incorporated herein in its entirety by reference.

### BACKGROUND OF THE INVENTION

1. Field of the Invention

The present invention relates to a steel, and more particularly, to a steel having high strength.

2. Description of the Related Art

Steels have been widely used for machine parts because of their inherent properties. To be used for machine parts, steels are usually first heat-treated to impart thereto strength, toughness and durability, all of which are qualities that machine parts require. In addition, for machine parts that are often exposed to a corrosive environment, surfaces thereof are further heat-treated to impart thereto corrosion resistance.

Nitriding is one of the methods for processing a metal surface to impart thereto a corrosion resistance thereof. Examples of the nitriding method include gas nitriding using NH₃ gas, salt bath nitriding using KCN, KCNO, etc., gas nitrocarburizing (carbo-nitriding) using a mixture of NH₃ gas and RX gas, i.e., endothermic gas, and ion nitriding involving an insertion of a mixture of N₂ and H₂ gas into plasma.

Generally, although nitriding is applied to steels to improve their abrasion (wear) resistance and fatigue resistance, it can also be carried out to improve the corrosion resistance thereof.

Of the nitriding methods stated above, the salt bath nitriding is most widely used for a variety of machine parts including automobile components, because the properties of chemicals for the salt bath and their melting points can be freely controlled to provide stability through a wide range of process temperatures without eroding a surface of an object being treated. To be more specific, in addition to its excellent thermal conductivity, soaking properties and easily controllable processing conditions, the salt bath nitriding is cheaper to design and maintain, compared with other nitriding methods. For example, it is easy to operate the salt bath, and the heating rate is 4 times faster in the salt bath than in the atmosphere. The salt bath is especially suitable for the heat treatment of steel for high speed devices which is sensitive to crystal (grain) growth. When a material treated in a salt bath comes into a contact with the atmosphere, a film including salt bath constituents is formed on the surface of the material, and prevents oxidation by preventing the material from directly contacting the atmosphere. Furthermore, the surface of the treated material is rather clean, and thus the salt bath is an ideal heat treating method and for both mass production and small-lot-sized production.

Cyanide-containing salt is generally used in the salt bath nitriding method, thereby producing cyanide ions inside a salt bath. Since the cyanide ions are classified as a toxic chemical, they must be carefully and tightly controlled, which can be an expensive proposition. Also, there is a problem of a cost involved for processing wastewater and gas.

Further, the nitriding treatment in a molten salt including cyanides is a nitrocarburizing (carbo-nitriding) method involving a simultaneous penetration of carbon and nitrogen. However, it has a shortcoming in that although the surface hardness of the treated material improves significantly, the tensile strength is only slightly enhanced. Such a conventional salt bath nitriding method using a cyanide salt also has a problem that its applications are limited to molds or gears since the depth to which the material can be nitrided is limited.

A representative conventional method of increasing the strength of steels is using a high-carbon steel which is obtained by increasing the amount of carbon contained in steel. In addition, examples of a high-strength steel having a tensile strength of 400 MPa or greater include a Dual Phase (DP) steel, a Complex Phase (CP) steel, a TRansformation Induced Plasticity (TRIP) steel, a TWinning Induced Plasticity (TWIP) steel, etc.

However, such a high-carbon steel and such a high-strength steel may be processed to have the shape of a desired machine part by using a special processing method suitable for the strength of the high-carbon steel and the highly strong steel. A mold or the like of a molding apparatus for processing the steel should have a high strength so as to conform to the strength of the steel. Accordingly, the high-carbon steel and the high-strength steel lower the productivity of machine parts or structures using these steels and increase the prices of the machine parts or structures.

In another conventional method to increasing the strength of steels, the abrasion (wear) resistance of steels, and the corrosion resistance of steels, nitrogen is diffused in a steel, and an iron-nitrogen compound is formed on the surface of the steel.

However, this method has a limit in that the amount of nitrogen that diffused in the steel is small because the nitrogen is consumed to form the iron-nitrogen compound on the surface of the steel, and thus the overall strength of the steel is not sufficiently increased although the hardness, strength, and corrosion-resistance of the steel's surface are improved. Therefore, although the formed steel is used for tools, engine parts, etc., it is not good to be used for exterior parts of vehicles.

### SUMMARY OF THE INVENTION

The present invention provides a method of nitriding a metal using non-cyanide salts, and a nitrided metal manufactured using the method.

The present invention also provides a salt bath nitriding method of nitriding a metal into which nitrogen has diffused, and a nitrided metal manufactured using the salt bath nitriding method.

The present invention also provides a salt bath nitriding method of nitriding a metal, by which hardness and tensile strength of the metal to be treated are increased, and a nitrided metal manufactured using the salt bath nitriding method.

The present invention also provides a salt bath nitriding method of nitriding a metal, by which a nitriding depth is maximized, and a nitrided metal manufactured using the salt bath nitriding method.

According to an aspect of the present invention, there is provided a method of nitriding a metal in a salt bath, the method including immersing a non-cyanide salt into the salt bath; melting the salt by heating and maintaining the molten salt at a predetermined temperature; and submerging the metal in the salt bath.

The non-cyanide salt may include at least one selected from the group consisting of sodium nitrate (NaNO₃), sodium nitrite (NaNO₂) KNO₃, KNO₂ and calcium nitrate (Ca(NO₃)₂), and the metal may be iron or steels.

The predetermined temperature is within a range of 400° C. to 700° C., and the submerging time is within a range of 1 minute to 24 hours.

When iron is nitrided in the salt bath including at least one of the group consisting of KNO₃, KNO₂, Ca(NO₃)₂, NaNO₃, and NaNO₂, the iron may be nitrided to a depth of 0.1 mm to 3.0 mm from the surface of the iron.

When a steel is nitrided in the salt bath including at least one of the group consisting of KNO₃, KNO₂, Ca(NO₃)₂, NaNO₃, and NaNO₂, the steel may be nitrided to a depth of 0.1 mm to 3.0 mm from the surface of the iron.

The steel includes ultra-low carbon steel, low carbon steel, medium carbon steel, high carbon steel, alloy steel, and IF steel.

The ultra-low carbon steel nitrided by the present invention has a surface hardness ranging from more than 120 Hv to equal to or less than 450 Hv. The low carbon steel has a surface hardness being more than 200 Hv to equal to or less than 410 Hv. The medium carbon steel has a surface hardness being more than 130 Hv to equal to or less than 420 Hv. The high carbon steel has a surface hardness being more than 150 Hv to equal to or less than 400 Hv. The alloy steel has a surface hardness being more than 200 Hv to equal to or less than 410 Hv. The IF steel has a surface hardness being more than 165 Hv to equal to or less than 400 Hv. The surface hardness of the steels nitrided by the present invention may be improved to a maximum of 420 Hv. The surface hardness of the iron nitrided by the present invention is also improved.

The ultra-low carbon steel nitrided by the present invention has a tensile strength ranging from more than 35 kgf/mm² to equal to or less than 110 kgf/mm². The low carbon steel has a tensile strength ranging from more than 45 kgf/mm² to equal to or less than 110 kgf/mm². The medium carbon steel has a tensile strength ranging from more than 45 kgf/mm² to equal to or less than 100 kgf/mm². The high carbon steel has a tensile strength ranging from more than 60 kgf/mm² to equal to or less than 95 kgf/mm². The alloy steel has a tensile strength ranging from more than 55 kgf/mm² to equal to or less than 110 kgf/mm². The tensile strength of IF steel and iron may be improved by the nitriding method of the present invention.

According to another aspect of the present invention, there is provided a steel including a first layer that includes an ultra-low carbon steel; and a second layer that contacts with the first layer, includes a first surface opposite to the first layer, includes a solid solution obtained by solid-solving nitrogen in the ultra-low carbon steel, and has a structure substantially the same as a structure of the first layer.

An iron-nitrogen compound may be neither comprised in the first surface of the second layer nor in an area adjacent to the first surface of the second layer.

The steel may further include a third layer that is formed on the second layer so as to prevent corrosion of the first surface and includes a second surface that contacts the first surface.

The steel may further include a fourth layer that is formed on the second layer, includes a third surface that contacts the first surface, and includes an iron-nitrogen compound.

The iron-nitrogen compound may be included in the first surface of the second layer or included in an area adjacent to the first surface of the second layer.

The ultra-low carbon steel may include no more than 0.01 wt % (not comprising 0 wt %) carbon.

According to another aspect of the present invention, there is provided a steel including a base metal that includes steel having no more than 0.01 wt % (not including 0 wt %) carbon and includes a surface; and a solid solution layer that is formed in an interior part of the base metal to be distant from the surface of the base metal, is obtained by solid-solving nitrogen at an interstitial site of the base metal, and has a structure substantially the same as a structure of the base metal.

An iron-nitrogen compound may be neither included in the surface of the solid solution layer nor in an area adjacent to the surface of the solid solution layer.

The steel may further include a first coating that is formed on and in contact with the surface of the solid solution layer so as to prevent corrosion of the solid solution layer.

The steel may further include a second coating that is formed on and in contact with the surface of the solid solution layer and comprises an iron-nitrogen compound.

The iron-nitrogen compound may be formed on the surface of the solid solution layer or formed in an area adjacent to the surface of the solid solution layer.

According to the above-described one or more embodiments of the present invention, the nitrogen solid solution layer is formed to have a sufficient depth within a steel, thereby increasing the strength of the steel. Thus, a steel according to the present invention may be applied to various fields such as light and highly-durable automobile parts and various structure materials.

Since the structure of the second layer obtained by nitrogen diffusion is the same as that of the first layer, the steel may have homogeneous physical properties across the first and second layers. Therefore, cracks or fractures are prevented from occurring.

Since an iron-nitrogen compound is not formed on the surface of the steel, more nitrogen may be diffused into the steel. Thus, a layer in which nitrogen is solid-solved in the steel may have a large thickness.

The he third or fourth layer are formed on the surface of the second layer so as to prevent the surface of the second layer from corroding. If the fourth layer is formed, abrasion resistance may increase.

Solid solving of nitrogen into the steel by using a non-cyanide salt may contribute to reducing environmental pollution and decreasing steel-processing costs.

Since the strength of the steel is increased after a desired shape is molded from an ultra-low carbon steel, the moldability, productivity, etc., of component parts may be increased.

Since the content of carbon in the steel does not exceed 0.01 wt %, the second layer may have an increased thickness.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional diagram of a steel according to an embodiment of the present invention;

FIG. 2 is a graph of the increasing rate of the tensile strength of the steel illustrated in FIG. 1 with respect to the amount of carbon contained in a base metal;

FIG. 3A is an optical microphotograph of a first layer included in the steel of FIG. 1;

FIG. 3B is an optical microphotograph of a second layer included in the steel of FIG. 1;

FIG. 3C is an optical microphotograph of the second layer of FIG. 3B when the base metal submerged in a molten salt was slowly cooled, according to an embodiment of the present invention;

FIG. 4 is a cross-sectional diagram of a steel manufactured using a manufacturing method according to an embodiment of the present invention;

FIG. 5 is a cross-sectional diagram of a steel according to another embodiment of the present invention;

FIG. 6 is a cross-sectional diagram of a steel according to another embodiment of the present invention;

FIG. 7 is a graph illustrating a difference between tensile strengths of a steel nitrided according to an embodiment of the present invention when the base metal submerged in a molten salt was rapidly cooled and when the base metal submerged in a molten salt was slowly cooled;

FIG. 8 is a graph illustrating a relationship between a nitriding time and a hardness profile in a steel nitrided according to another embodiment of the present invention;

FIG. 9 is a graph illustrating a relationship between another nitriding time and another hardness profile in the steel nitrided according to the embodiment mentioned in FIG. 8;

FIG. 10 is a graph illustrating a relationship between a nitriding temperature and a hardness profile in the steel nitrided according to the embodiment mentioned in FIG. 8;

FIG. 11 is a graph illustrating relationship between the nitriding time and the surface hardness of a steel nitrided according to another embodiment of the present invention;

FIG. 12 is a graph illustrating relationship between the nitriding temperature and time and the hardness profile in the steel nitrided according to the embodiment mentioned in FIG. 11;

FIG. 13 is a graph illustrating relationship between the nitriding time and the hardness profile in the steel nitrided according to the embodiment mentioned in FIG. 11;

FIG. 14 is a graph illustrating the hardness profile in a steel nitrided according to another embodiment of the present invention;

FIG. 15 is a graph illustrating the hardness profile in a steel nitrided according to another embodiment of the present invention; and

FIG. 16 is a graph illustrating relationship between a mixture ratio of a mixed salt and the hardness profile in the steel nitrided according to the embodiment mentioned in FIG. 15.

### DETAILED DESCRIPTION OF THE INVENTION

Hereinafter, the present invention will be described in more detail.

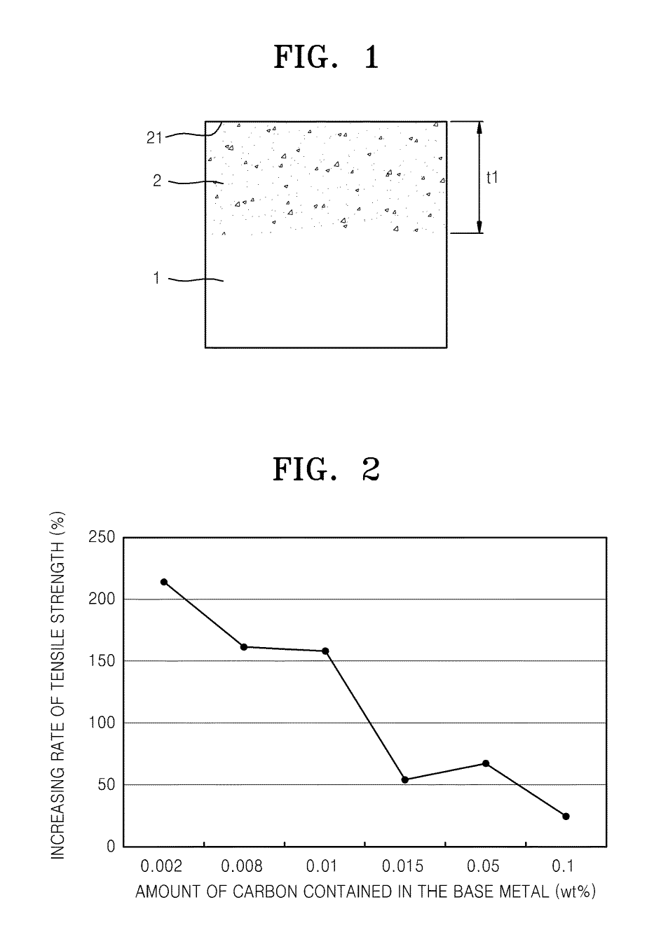

FIG. 1 is a cross-sectional diagram of a steel according to an embodiment of the present invention.

Referring to FIG. 1, the steel includes a first layer 1, and a second layer 2 adjacent to the first layer 1.

The first layer 1 is a part of a base metal which is formed of steel and is maintained without changes. The first layer 1 may not include an iron-nitrogen compound. The first layer 1 may include an extremely small amount of nitrogen as an alloy element for a specific purpose.

The first layer 1 may be formed of an ultra-low carbon steel that contains no more than 0.01 wt % (not including 0 wt %) carbon, because the first layer 1 serves as a base metal for forming the second layer 2 and thus should facilitate thick formation of the second layer 2 as will be described later.

The second layer 2 is a solid solution layer in which nitrogen is solid-solved at an interstitial site of an iron. The second layer 2 includes a first surface 21 opposite the first layer 1. An iron-nitrogen compound such as Fe₂N, Fe₃N, or Fe₄N exists neither in the second layer 2 nor on the first surface 21 of the second layer 2.

Since the second layer 2 includes no iron-nitrogen compounds, nitrogen can be diffused to a sufficient depth from the first surface 21. Thus, the second layer 2 has a sufficiently large thickness t1 and thus the steel according to the present invention may have a greatly increased tensile strength.

The thickness t1 of the second layer 2 may be appropriately controlled according to a desired tensile strength. For example, if the tensile strength of the steel is required to be relatively high, the thickness t1 of the second layer 2 is set to be thick. If the tensile strength of the steel is required to be a relatively low, the thickness t1 of the second layer 2 is set to be thin.

The second layer 2 is a solid solution layer in which nitrogen is diffused from a surface of the base metal and solid-solved at the interstitial site of the iron.

Like the first layer 1, the second layer 2 may be formed by using an ultra-low carbon steel that contains no more than 0.01 wt % (not including 0 wt %) carbon. This is because the second layer 2 is a solid solution layer formed due to the diffusion of nitrogen from the surface of the base metal as described above. Thus, if the content of carbon exceeds 0.01 wt %, the thickness t1 of the second layer 2 is not sufficiently large, and thus it is difficult to increase the tensile strength of the steel.

FIG. 2 is a graph of the increasing rate of the tensile strength of the steel illustrated in FIG. 1 with respect to the amount of carbon contained in the base metal. The increasing rate of the tensile strength denotes an increasing rate of the tensile strength between before and after the formation of the second layer 2. FIG. 2 shows a result of a tensile strength test performed on the steels having 0.002 wt % carbon, 0.008 wt % carbon, 0.01 wt % carbon, 0.015 wt % carbon, 0.05 wt % carbon, and 0.1 wt % carbon, respectively, after they are submerged in a sodium nitrate (NaNO₃) molten salt of 650° C. for 12 hours, rapidly cooled with cooling water, and then oxidized films are removed from the steels.

As shown in FIG. 2, the increasing rate of the tensile strength of a steel containing no more than 0.01 wt % carbon is 100% or greater. That is, the steel has a tensile strength twice or greater than the tensile strength of the base metal of the steel. On the other hand, when the content of carbon exceeds 0.01 wt %, the steel still has a tensile strength increase, but it is less than 100%. Thus, a practical benefit or economical benefit of the formation of the second layer 2 to increase the tensile strength is small.

A reason for this phenomenon may be that, since a site in iron where carbon is solid-solved is similar to that where nitrogen is solid-solved, and carbon and nitrogen have similar atomic sizes, if some amount of carbon has been solid-solved in iron, it is difficult for as much nitrogen as the amount of solid-solved carbon to be solid-solved in the iron. However, the present invention is not limited to this reason, and reductions of the thickness t1 of the second layer 2 and the increasing rate of the tensile strength of the steel may be due to the other reasons which are complicated and unknown.

In the present invention, the first layer 1 and the second layer 2 may have substantially the same structures, which means that the structures of the first and second layers 1 and 2 have an identical morphology without having discontinuities.

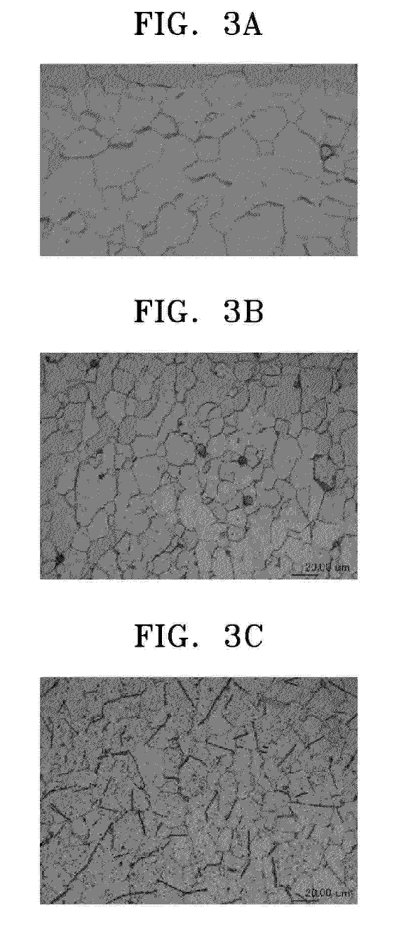

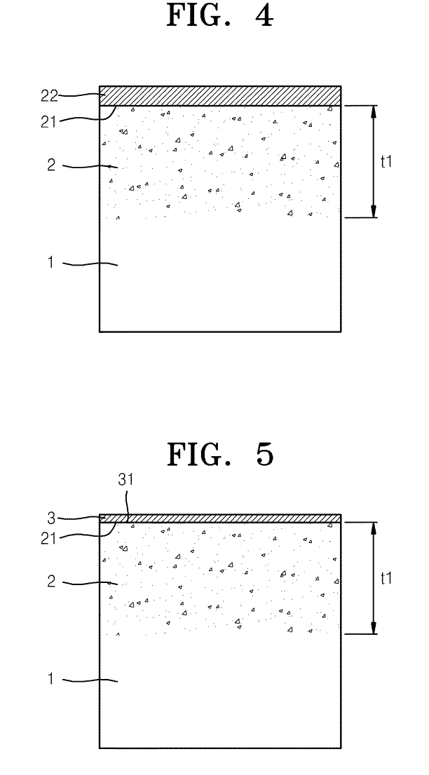

FIG. 3A is an optical microphotograph of the first layer 1 of the steel of FIG. 1, and FIG. 3B is an optical microphotograph of the second layer 2 of the steel of FIG. 1. As illustrated in FIGS. 3A and 3B, the first and second layers 1 and 2 have an identical structure. Thus, the steel has a homogeneous structure across the first and second layers 1 and 2 and accordingly may have the same physical properties and prevent the occurrence of cracks or fractures.

A method of forming the second layer 2, according to an embodiment of the present invention, will now be described.

First, a molten salt is prepared. The molten salt does not include a conventional molten salt containing a cyanide (CN), such as KCN, NaCN, or the like, but includes a non-cyanide molten salt, for example, at least one salt selected from the group consisting of NaNO₃, NaNO₂, KNO₃, KNO₂, and Ca(NO₃)₂.

A bath of the molten salt (hereinafter, referred to as a molten salt bath) is maintained at a constant temperature ranging between 400° C. and 800° C.

Then, the salts included in the molten salt bath causes a nitrogen production reaction as shown in the following Reaction Schemes.

Reaction Scheme 1 shows a nitrogen production reaction of a NaNO₃ or NaNO₂ molten salt bath.

NaNO₃→NaNO₂+1/2O₂

2NaNO₂→Na₂O+NO₂+NO

2NaNO₂+2NO→2NaNO₃+N₂ [Reaction Scheme 1]

Reaction Scheme 2 shows a nitrogen production reaction of a KNO₃ or KNO₂ molten salt bath.

KNO₃→KNO₂+1/2O₂

2KNO₂→K₂O+NO₂+NO

2KNO₂+2NO→2KNO₃+N₂ [Reaction Scheme 2]

Reaction Scheme 3 shows a nitrogen production reaction of a Ca(NO₃)₂ molten salt bath.

Ca(NO₃)₂→CaO+2NO₂+1/2O₂

2NO₂→2O₂+N₂ [Reaction Scheme 3]

As such, NO and NO₂ are produced in the molten salt bath, and the NO and NO₂ produce activation nitrogen N according to a reaction with iron and thus the activation nitrogen N is diffused into the base metal, as will be described later.

Thereafter, as described above, a base metal formed of steel containing no more than 0.01 wt % carbon is submerged in the molten salt bath for a certain period of time, for example, for 10 minutes to 24 hours.

The base metal may be molded to have a shape desired by a user. In other words, since the base metal is formed of an ultra-low carbon steel that contains no more than 0.01 wt % carbon, the base metal has a low tensile strength and a high flexibility and thus is easily processed. Therefore, it is very easy to mold a desired shape from the ultra-low carbon steel. In addition, the durability of a mold of a molding device may increase.

When the base metal that is simply molded as described above is submerged in the molten salt bath, the NO and the NO₂ produced in the salt bath react with iron (Fe), the reaction happening on the surface of the base metal, according to Reaction Schemes 4 through 9.

Fe+NO→FeO+N [Reaction Scheme 4]

3/4Fe+NO→1/4Fe₃O₄+N [Reaction Scheme 5]

2/3Fe+NO→1/3Fe₂O₃+N [Reaction Scheme 6]

2Fe+NO₂→2FeO+N [Reaction Scheme 7]

3/2Fe+NO₂→1/2Fe₃O₄+N [Reaction Scheme 8]

4/3Fe+NO₂→2/3Fe₂O₃+N [Reaction Scheme 9]

The following Equations 1 through 6 show calculations of the Gibbs free energy of Reactions Schemes 4 through 9. The calculations of the Gibbs free energy are introduced by R. C. Weast (Ed.) in the Handbook of Chemistry and Physics, 49th ed., The Chemical Rubber co., 1968, P.D-22.

ΔG₁^{∘}=−86910−10.98T log T+2.16×10⁻³T²+0.47×10⁵T⁻¹+50.8T [Equation 1]

ΔG₂^{∘}=−88667.5−1.7475T log T−3.5625×10⁻³T²+0.09125×10⁵T⁻¹+20.4775T [Equation 2]

ΔG₃^{∘}=−88256.7−4.3333T log T−0.9333×10⁻³T²+0.665×10⁵T⁻¹+38.287T [Equation 3]

ΔG₄^{∘}=−138370−23.05T log T+5.485×10⁻³T²+0.275×10⁵T⁻¹+83.46T [Equation 4]

ΔG₅^{∘}=−141885−2.405T log T−5.96×10⁻³T²−0.4825×10⁵T⁻¹+22.815T [Equation 5]

ΔG₆^{∘}=−141063.3−9.7567T log T−0.7017×10⁻³T²+0.665×10⁵T⁻¹+58.433T [Equation 6]

Referring to Equations 1 through 6, all Gibbs free energy values ΔG^{∘} are negative within a temperature range of 400° C. to 800° C. (absolute temperature of 673.25K to 1073.25K). Therefore, the Reaction Schemes 4 through 9 corresponding to Equations 1 through 6, respectively, show spontaneous reactions within the temperature range.

Consequently, the NO and NO₂ react with Fe to form an Fe—O compound, that is, Fe oxide, on the surface of the base metal according to Reaction Schemes 4 through 9, and produce activation nitrogen N. The activation nitrogen N is diffused to an interstitial site of the Fe, whereby solid solution strengthening is performed on the steel.

The molten salt bath further contains nitrogen (N₂) and oxygen (O₂), which respectively react with Fe according to Reaction Schemes 10 through 13.

4Fe+1/2N₂→Fe₄N [Reaction Scheme 10]

Fe+1/2O₂→FeO [Reaction Scheme 11]

2Fe+3/2O₂→Fe₂O₃ [Reaction Scheme 12]

3Fe+2O₂→Fe₃O₄ [Reaction Scheme 13]

Gibbs free energy values ΔG^{∘} of Reaction Schemes 10 through 13 may be calculated by ΔH^{∘}−TΔS^{∘}, namely, using Equations 7 through 10. The calculations of the Gibbs free energy are based on the Thermodynamics of Materials by David V. Ragone.

ΔG₇^{∘}=ΔH^{∘}−TΔS=−33500+70T [Equation 7]

ΔG₈^{∘}=ΔH^{∘}−TΔS=−263700+64.35T [Equation 8]

ΔG₉^{∘}−ΔH^{∘}−TΔS=−814000+251T [Equation 9]

ΔG₁₀^{∘}=ΔH^{∘}−TΔS=−1100000+307T [Equation 10]

Within the temperature range according to the present invention, ΔG₇^{∘} has a positive value of 20,000 or greater, or ΔG₈^{∘} through ΔG₁₀^{∘} all have negative values of −200,000 or less. Accordingly, Reaction Scheme 10 among Reaction Schemes 10 through 13 is a non-spontaneous reaction, and Reaction Schemes 11 through 13 are spontaneous reactions. Thus, as described above, an iron-nitrogen compound, which is to be produced according to Reaction Scheme 10, is not produced in the second layer 2, which is a nitrogen solid solution layer according to the present invention, until an external special treatment is performed on a surface of the second layer 2.

After the base metal is processed in the molten salt bath at the temperature ranging from 400° C. to 800° C. as described above, the base metal is rapidly cooled with water, oil, or the like.

When the base metal processed within the molten salt bath is rapidly cooled, the second layer 2, which is a nitrogen solid solution layer, may have a structure as illustrated in FIG. 3B as described above, and consequently the structure of the second layer 2 is the same as that of the base metal (see FIG. 3A). FIG. 3C is an optical microphotograph of a structure of the second layer 2 when the base metal processed in the molten salt path is slowly cooled at room temperature, according to an embodiment of the present invention. As illustrated in FIG. 3C, when the base metal processed in the molten salt bath is slowly cooled, the second layer 2 has a needle structure, in contrast with that of the first layer 1. Thus, in this case, an effect of preventing the occurrence of cracks and factures due to homogeneity between the structures of the first and second layers 1 and 2 is not obtained.

The tensile strength of a steel, according to an embodiment of the present invention, greatly varies according to a cooling condition of a base metal processed in a molten salt bath. The tensile strength of the steel is greater when the base metal is rapidly cooled than when the base metal is slowly cooled.

FIG. 4 is a cross-sectional diagram of a steel manufactured using a manufacturing method according to another embodiment of the present invention.

As illustrated in FIG. 4, a rapidly cooled steel has a structure in which the second layer 2, which is a nitrogen solid-solution layer, is formed on the first layer 1 and an oxidized film 22 including Fe oxide is formed on the first surface 21 of the second layer 2. Since the formation of the oxidized film 22 corresponds to a spontaneous reaction and the formation of an iron-nitrogen compound corresponds to a non-spontaneous reaction as described above, the nitrogen solid-solved layer, that is, the second layer 2, is formed on the base metal before the iron-nitrogen compound is formed, and the oxidized film 22 is formed on the first surface 21 of the second layer 2.

The oxidized film 22, which is formed of a Fe—O compound formed on the surface of the base metal may be decomposed. Even if an iron-nitrogen compound is formed on the surface of the base metal, the iron-nitrogen compound may be decomposed. These decompositions occur as in Reaction Schemes 14 and 15.

Fe₄N→4Fe+1/2N₂ [Reaction Scheme 14]

FeO→Fe+1/2O₂ [Reaction Scheme 15]

Decomposition energies during these decompositions may be calculated using Equations 11 and 12, respectively. Calculations of the Gibbs free energies during these decompositions are introduced in Metallurgical Thermo-chemistry, 5th ed., O. Kubaschewski and C. B. Alcock.

ΔG₁₁^{∘}=A+BT log T+CT=200−11.62T log T+24.85 T [Equation 11]

ΔG₁₂^{∘}=A+B log T+CT=63310+0T log T+15.62T [Equation 12]

Within the temperature range according to the present invention, ΔG₁₁^{∘} has a negative value, and ΔG₁₂^{∘} has a positive value. Accordingly, Reaction Scheme 14 is a spontaneous reaction, and Reaction Scheme 15 is a non-spontaneous reaction. The Fe—O compound is not spontaneously decomposed according to Reaction Scheme 15, and the Fe—O compound, that is, the oxidized film 22, is formed. The iron-nitrogen compound is spontaneously decomposed according to Reaction Scheme 14, and thus even when a small amount of iron-nitrogen compound is formed on the second layer 2, the iron-nitrogen compound is spontaneously decomposed.

As such, the iron-nitrogen compound exists neither around the surface of the second layer 2 nor in the oxidized film 22. The second layer 2 and the oxidized film 22 are simultaneously formed.

In the above-described method of forming the second layer 2, according to an embodiment of the present invention, the oxidized film 22 is essentially formed, and the thickness to which the second layer 2 is formed may be predicted using the thickness of the oxidized film 22.

Next, the oxidized film 22 is removed through a surface scale removing operation, thereby completing the formation of a steel as illustrated in FIG. 1.

According to the method of forming the second layer 2, a compound is not formed because nitrogen and iron react with each other on the surface of the steel, and thus more nitrogen may be diffused to the interstitial site of the iron and the diffusion of the nitrogen may be deep. Accordingly, in this method, the thickness t1 of the second layer 2 may be large as compared with a conventional nitriding method for forming an iron-nitrogen compound layer on the surface of a steel. Since the thickness t1 of the second layer 2 is somewhat proportional to the temperature of the molten salt bath and a processing duration, when the second layer 2 is formed to be thick, the temperature of the molten salt bath may be increased as much as possible within an allowable temperature range, and the processing duration may be long.

The nitrogen diffused into the surface of the base metal is the activation nitrogen N produced according to Reaction Schemes 4 through 9. The more the amount of activation nitrogen N is, the more the amount of nitrogen diffused into the steel is. However, the amount of activation nitrogen N in Reaction Schemes 4 through 9 is related with the amounts of NO and NO₂ that react with Fe.

Therefore, during this nitrogen process, high-temperature air is introduced into the molten salt bath, and nitrogen and oxygen in the introduced air produce NO and NO₂, so that the NO and NO₂ may participate in reactions as illustrated in Reaction Schemes 4 through 9. Alternatively, separate gas including NO and NO₂ may be introduced into the molten salt bath.

Although the method of forming the second layer 2 according to an embodiment of the present invention has been illustrated above, the second layer 2 may be formed using the other methods.

In the above-described method of forming the second layer 2 according to an embodiment of the present invention, the first surface 21 is exposed to light, and thus the steel including the second layer 2 may not be resistant to corrosion.

Accordingly, as illustrated in FIG. 5, in a steel according to another embodiment of the present invention, a third layer 3 having a second surface 31 that contacts the first surface 21 may be formed on the second layer 2 in order to prevent the first surface 21 of the second layer 2 from corroding.

The third layer 3 may be a phosphate coating, and is not limited thereto. For example, the second layer 2 may be plated or coated with any material capable of easily adhering to the first surface 21 and preventing the second layer 2 from corroding.

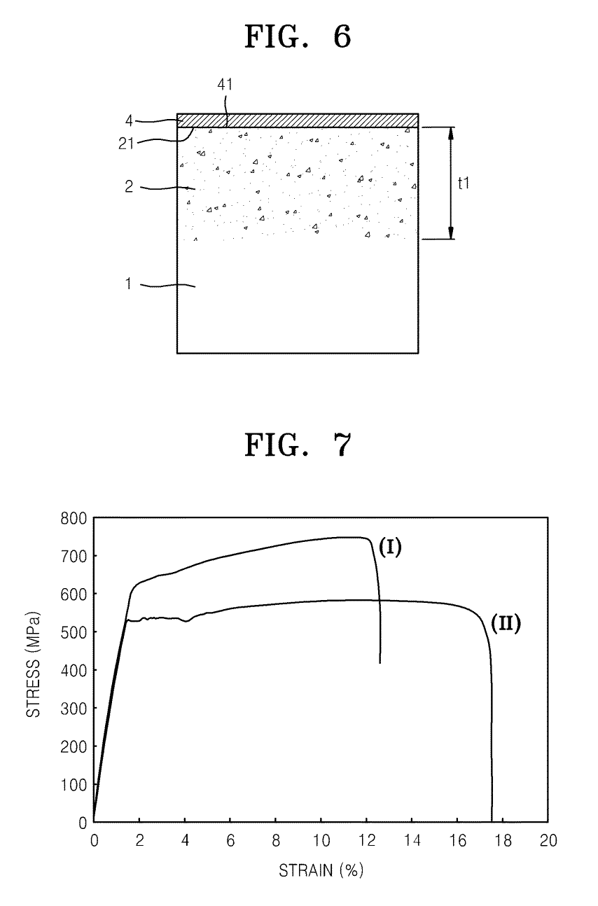

FIG. 6 is a cross-sectional diagram of a steel according to another embodiment of the present invention.

As described above, when the first surface 21 of the second layer 2 is exposed to light, the steel is prone to corrosion. In order to prevent this corrosion and increase the abrasion resistance of the first surface 21, a fourth layer 4 of a iron-nitrogen compound may be formed to cover the first surface 21 of the second layer 2, after the second layer 2 is formed. Thus, the fourth layer 4 has a third surface 41 that contacts the first surface 21 of the second layer 2, and prevents the first surface 21 from corroding.

The fourth layer 4 may be formed on the first surface 21 of the second layer 2 by gas nitriding. The fourth layer 4 may be formed of at least one layer formed of ε-Fe₂N, ε-Fe₃N, or γ-Fe₄N.

An iron-nitrogen compound may be formed around the first surface 21 of the second layer 2, which is adjacent to the fourth layer 4.

When the fourth layer 4, which is a nitride layer, is formed on the first surface 21 of the second layer 2, the surface hardness, abrasion resistance, and corrosion resistance of the steel may increase.

As such, in the present invention, a desired shape is easily molded using an ultra-low carbon steel, and the tensile strength of the steel is increased due to the use of the above-described treatment, thereby maximizing the mass productivity of steel products.

As shown in Table 1, metals nitrided using a salt bath nitriding method according to the present invention, and including carbon steel (including ultra-low carbon steel, low carbon steel, medium carbon steel, and high carbon steel), alloy steel, Interstitial-Free (IF) steel, and iron have nitrided depths of 0.1 mm to 3.0 mm from the surfaces of the metals. The range of nitrided depth/diffusion layer thickness obtained according to the present invention is 2 to 6 times larger than that obtained using conventional nitriding methods, which means that a nitrided/diffusion layer formed using the salt bath nitriding method according to the present invention extends from the surface of a metal to the inside area of the metal, and consequently the surface hardness and tensile strength of the metal also improve as compared to those of metal nitrided using the conventional nitriding methods. The reference for Table 1 is K. Funatani, “Low-Temperature Salt Bath Nitriding of Steels”, Metal Science and Heat Temperature, Vol. 46, No. 7, PP. 277-281 (2004).

TABLE 1

| | | | Thickness of |
|---|---|---|---|
| | Temperature | | diffusion layer |
| Nitriding method | (K) | Type of Steel | (μm) |
| Nitriding process | 953 | Low carbon steel | 3000 |
| according to the | 913 | IF steel | 1500 |
| present invention | | | |
| Tufftride TFI | 853 | 1015 | 800 |
| | 853 | 1045 | 780 |
| | 853 | 34Cr4 | 480 |
| | 853 | X210Cr12 | 160 |
| Tufftride NSI | 843 | 1015 | 780 |
| | 843 | SCM435 | 171 |
| “Soft” Nitriding in | 843 | SC2250 | 353 |
| gas medium | 793 | 38CrMoAl | 78-97 |
| | — | 40Cr | 63-80 |
| Gas Nitriding | 773 | SAE9254 | 49 |
| Plasma Nitriding | 793 (Pused) | 722M24 | 72 |
| | 793 (DC) | 722M24 | |
| Plasma Nitriding | 833 | En40B | 100 |
| | 813 | En19 | 110 |
| | 793 | Nirtaps | 46 |
| | 823 | 36CrMo | 100 |
| | 793 | 36CrMo + 0.1Y | 200 |
| | 823 | 36CrMo + 0.1Ce | 215 |
| Low-temperature | 753 | SKD61 | 150 |
| salt bath | 843 | SKD61 | 106 |
| Nitriding | 753 | SCM435 | 141 |
| (palsonite) | 843 | SCM435 | 200 |

Hereinafter, nitriding methods according to embodiments of the present invention will be described in detail with reference to the attached drawings.

### EMBODIMENT I

FIG. 7 is a graph illustrating a difference between tensile strengths of a steel nitrided according to an embodiment of the present invention when the base metal submerged in a molten salt was rapidly cooled (see (I)) and when the base metal submerged in a molten salt was slowly cooled (see (II)), wherein the steel has 0.002 wt % carbon and are cooled after they are submerged in a NaNO₃ molten salt of 650° C. for 5 hours. The rapid cooling (I) denotes cooling using general cooling water, and the slow cooling (II) denotes leaving the steel at room temperature. An IF steel, which is a base metal, has a tensile strength of 300 MPa. In the case of rapid cooling (I), the tensile strength of the IF steel increased to 750 MPa. In the case of slow cooling (II), the tensile strength of the IF steel decreased to 540 MPa.

### EMBODIMENT II

In accordance with the current embodiment of the present invention, a steel is nitrided using NaNO₃ molten salt. The nitrided steel includes ultra-low carbon steel, low carbon steel, medium carbon steel, high carbon steel, and alloy steel.

Each of the ultra-low carbon steel, the low carbon steel, the medium carbon steel, the high carbon steel, and the alloy steel is submerged in a bath of the NaNO₃ molten salt (hereinafter, referred to as a NaNO₃ molten salt bath) for 2 hours at a temperature of 500° C.

Table 2 shows changes in surface hardness and tensile strength of samples nitrided in the molten salt bath, wherein the surface hardness was measured using a Vickers hardness tester under a load of 1 kgf.

In the case of ultra-low carbon steel, the surface hardness increases by 119% and the tensile strength increases by 47%. In the case of low carbon steel, the surface hardness increases by 47% and the tensile strength increases by 19%.

In the case of medium carbon steel, the surface hardness increases by 32% and the tensile strength increases by 18%. In the case of high carbon steel, the surface hardness increases by 28% and the tensile strength increases by 16%. In the case of alloy steel, the surface hardness increases by 24% and the tensile strength increases by 17%.

That is, in the case of steel, the surface hardness increases by 20% to 120% and the tensile strength increases by 15% to 50%.

The differences in the amount of increase in the surface hardness depending on the steel type can be attributed to the differences in the nitrogen diffusion rate associated with each type of steel determined by the carbon content therein.

TABLE 2

| | | | | Change of Tensile Strength | | |
|---|---|---|---|---|---|---|
| | Change of Hardness (Hv) | | | (kgf/mm²) | | |
| | Before | After | | Before | After | |
| | nitriding | nitriding | Increased | nitriding | nitriding | Increased |
| Type of steel | process | process | rate (%) | process | process | rate (%) |
| Ultra low | 128 | 280 | 119 | 34 | 50 | 47 |
| carbon steel | | | | | | |
| Low | 194 | 286 | 47 | 62 | 74 | 19 |
| carbon | | | | | | |
| steel | | | | | | |
| Medium carbon | 183 | 241 | 32 | 56 | 66 | 18 |
| steel | | | | | | |
| High | 230 | 294 | 28 | 73 | 85 | 16 |
| carbon | | | | | | |
| steel | | | | | | |
| Alloy steel | 226 | 281 | 24 | 71 | 83 | 17 |

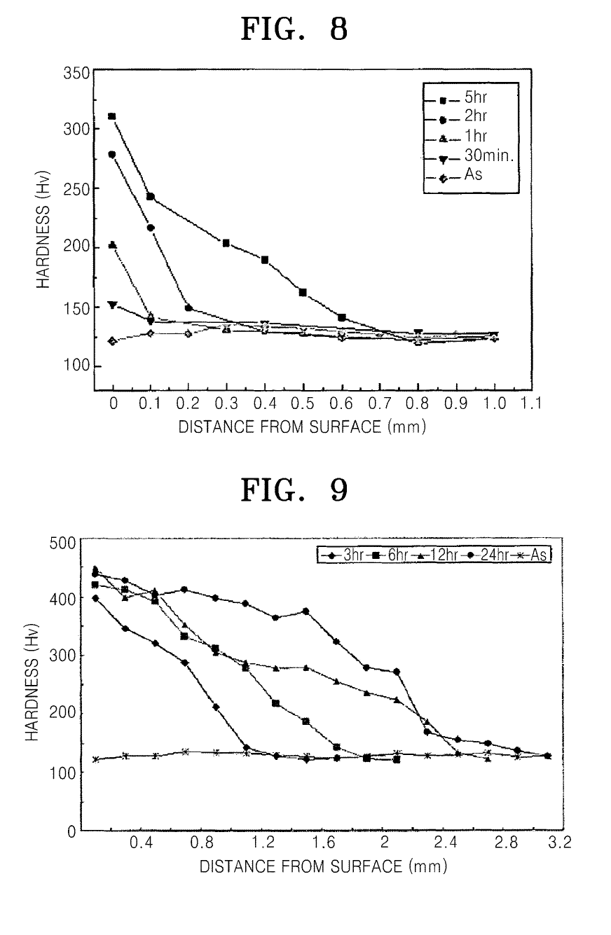

FIG. 8 is a graph showing the hardness distribution in the thickness direction of the ultra-low carbon steel before (indicated by As) and after nitriding in the NaNO₃ molten salt bath at 500° C. for 30 minutes, 1 hour, 2 hours and 5 hours, respectively.

The nitrided depth or the diffusion depth increases with an increase in nitriding time, and the hardness decreases with an increase in a distance from the surface of the ultra-low carbon steel in the thickness direction thereof because the nitrogen concentration decreases with an increase in the distance from the surface. When the ultra-low carbon steel is nitrided for 5 hours, it can be seen that the ultra-low carbon steel is nitrided to a depth of about 0.6 mm from the surface.

FIG. 9 shows the hardness distribution in the thickness direction of ultra-low carbon steel nitrided in the NaNO₃ molten-salt bath at 680° C. for 3, 6, 12 and 24 hours, respectively, wherein the hardness is measured using a Vickers hardness tester under a load of 3 kgf.

As shown in FIG. 9, the nitrided depth or the diffusion depth of the steel increases with increasing nitriding time. The nitrided depth of the steel after nitriding for 24 hours is about 3 mm, which is 6 times deeper than that obtained from a conventional nitriding method.

Also, the surface hardness after nitriding is 450 Hv, which is more than 4 times higher than that of a non-treated specimen.

Accordingly, the nitriding method according to the current embodiment of the present invention can increase the nitrided depth of the steel by 2 to 6 times as compared to a conventional cyanide-based salt bath nitriding method.

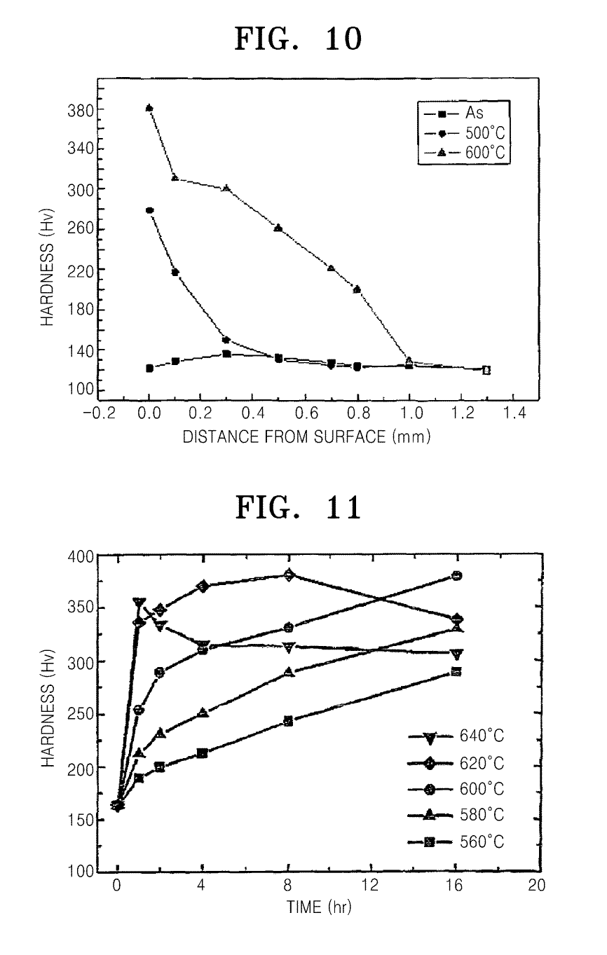

FIG. 10 shows hardness distributions in the thickness direction of the ultra-low carbon steel before and after nitriding in the NaNO₃ molten-salt bath at 500° C. and 600° C. for 3 hours. The nitrided depth of the steel nitrided at 600° C. is 3 times deeper than that of the steel nitrided at 500° C. The surface hardness of the steel nitrided at 600° C. is 100 Hv higher than that of the steel nitrided at 500° C. That is, the surface hardness and nitrided depth of the steel increase with increasing nitriding temperature.

Table 3 shows changes in the tensile strength of ultra low carbon steel depending on the nitriding temperature, wherein the samples are nitrided for 3 hours at 450° C., 500° C., 550° C., and 600° C., respectively, using the salt bath nitriding method according to embodiment II of the present invention.

As shown in FIG. 10, in the case of the nitriding temperature of 450° C., the tensile strength increases by 5%. As the temperature increases, the tensile strength of the steel also increases. Accordingly, when the temperature is 600° C., the tensile strength increases by 134%.

TABLE 3

| | | Nitriding | Tensile | Increased |
|---|---|---|---|---|
| | Nitriding | time | strength | rate |
| Division | temperature (° C.) | (h) | (kgf/mm²) | (%) |
| Before nitriding | — | — | 34.8 | 0 |
| After nitriding | 450 | 3 | 36.6 | 5 |
| | 500 | | 50.8 | 46 |
| | 550 | | 64.5 | 85 |
| | 600 | | 81.4 | 134 |

That is, since it is possible to simultaneously improve the hardness and the tensile strength by nitriding the steel according to the current embodiment, the present invention can be applied to diverse fields including diverse components and structural members.

### EMBODIMENT III

In accordance with the current embodiment of the present invention, steel is nitrided using NaNO₂ molten salt.

Steels including ultra-low carbon steel, low carbon steel, medium carbon steel, high carbon steel, and alloy steel are submerged in a NaNO₂ molten salt bath at 450° C. for 2 hours.

Table 4 shows changes in the surface hardness and tensile strength of samples nitrided in the molten salt bath, wherein the surface hardness is measured using a Vickers hardness tester under a load of 1 kgf.

For ultra-low carbon steel, the surface hardness increases by 54% and the tensile strength increases by 21%. For low carbon steel, the surface hardness increases by 32% and the tensile strength increases by 15%.

For medium carbon steel, the surface hardness increases by 19% and the tensile strength increases by 13%. For high carbon steel, the surface hardness increases by 18% and the tensile strength increases by 12%.

For alloy steel, the surface hardness increases by 17% and the tensile strength increases by 14%.

That is, in the case that steels are nitrided by the molten salt bath nitriding method according to the current embodiment of the present invention, the surface hardness increases by 15% to 60%, and the tensile strength increases by 10% to 25%.

Accordingly, the molten salt bath nitriding method according to the current embodiment of the present invention also increases the surface hardness and tensile strength of the steels.

TABLE 4

| | | | | Change of Tensile Strength | | |
|---|---|---|---|---|---|---|
| | Change of Hardness (Hv) | | | (kgf/mm²) | | |
| | Before | After | | Before | After | |
| | nitriding | nitriding | Increased | nitriding | nitriding | Increased |
| Type of steel | process | process | rate (%) | process | process | rate (%) |
| Ultra low | 128 | 197 | 54 | 34 | 41 | 21 |
| carbon | | | | | | |
| steel | | | | | | |
| Low | 194 | 257 | 32 | 62 | 71 | 15 |
| carbon | | | | | | |
| steel | | | | | | |
| Medium carbon | 183 | 218 | 19 | 56 | 63 | 13 |
| steel | | | | | | |
| High | 230 | 271 | 18 | 73 | 82 | 12 |
| carbon | | | | | | |
| steel | | | | | | |
| Alloy steel | 226 | 265 | 17 | 71 | 81 | 14 |

### EMBODIMENT IV

In accordance with the current embodiment of the present invention, steels are nitrided using KNO₂ molten salt.

The steels including ultra-low carbon steel, low carbon steel, high carbon steel, and alloy steel are submerged in a KNO₂ molten salt bath at 480° C. for 2 hours.

Table 5 shows changes in the hardness and tensile strength of samples submerged in the KNO₂ molten salt bath, wherein the surface hardness is measured using a Vickers hardness tester under a load of 1 kgf.

For ultra-low carbon steel, the surface hardness increases by 45% and the tensile strength increases by 15%. For low carbon steel, the surface hardness increases by 25% and the tensile strength increases by 11%.

For high carbon steel, the surface hardness increases by 17% and the tensile strength increases by 10%. For alloy steel, the surface hardness increases by 12% and the tensile strength increases by 11%.

That is, when the steels are nitrided using the molten salt bath nitriding method according to embodiment IV of the present invention, the surface hardness increases by 10% to 50%, and the tensile strength increases by 10% to 20%.

Accordingly, the molten salt bath nitriding method according to the current embodiment of the present invention also increases the surface hardness and the tensile strength of the steels.

TABLE 5

| | | | | Change of Tensile Strength | | |
|---|---|---|---|---|---|---|
| | Change of Hardness (Hv) | | | (kgf/mm²) | | |
| | Before | After | | Before | After | |
| Type of | nitriding | nitriding | Increased rate | nitriding | nitriding | Increased |
| steel | process | process | (%) | process | process | rate (%) |
| Ultra low | 128 | 186 | 45 | 34 | 39 | 15 |
| carbon | | | | | | |
| steel | | | | | | |
| Low | 194 | 243 | 25 | 62 | 69 | 11 |
| carbon | | | | | | |
| steel | | | | | | |
| High | 230 | 268 | 17 | 73 | 80 | 10 |
| carbon | | | | | | |
| steel | | | | | | |
| Alloy | 226 | 252 | 12 | 71 | 97 | 11 |
| steel | | | | | | |

### EMBODIMENT V

In the current embodiment of the present invention, steel is nitrided using KNO₃ molten salt.

The steel to be nitrided is IF steel, which includes carbon (C) of 0.003 wt %, manganese (Mn) of 1.23 wt %, aluminum (Al) of 0.037 wt %, titanium (Ti) of 0.027 wt %, phosphorus (P) of 0.050 wt %, nitrogen (N) of 0.002 wt %, and sulfur (S) of 0.008 wt %.

The IF steel is nitrided in a KNO₃ molten salt bath at 560° C., 580° C., 600° C., 620° C., and 640° C., respectively.

FIG. 11 shows the surface hardness of the IF steel nitrided in the KNO₃ molten bath according to nitriding time and nitriding temperature.

As shown in FIG. 11, as the nitriding time and nitriding temperature increase, the surface hardness increases under most temperature conditions. Although the increase of the surface hardness can be explained as solution strengthening, the present invention is not limited to this explanation.

However, when the nitriding time in the KNO₃ molten salt at 620° C. exceeds 8 hours, or the nitriding time in the KNO₃ molten salt at 640° C. exceeds one hour, the surface hardness decreases. It is understood that this decrease in the surface hardness is caused due to the formation of a nitrided layer in the grain boundaries of the IF steel.

In Table 6, the surface hardness values of the IF steel nitrided by the method according to embodiment IV of the present invention are given. When the IF steel is nitrided at temperatures of 560° C. to 640° C., the surface hardness increases by 75% to 130%.

TABLE 6

| | Change of Hardness (Hv) | | | | Change of Hardness (Hv) | | |
|---|---|---|---|---|---|---|---|
| | after nitriding for 16 h. | | | | after nitriding for 1 h. | | |
| Nitriding | Before | After | Increasing | Nitriding | Before | After | Increased |
| Temperature | nitriding | nitriding | rate (%) | Temperature | nitriding | nitriding | rate (%) |
| 560° C. | 165 | 289 | 75 | 620° C. | 165 | 336 | 104 |
| 580° C. | 165 | 329 | 99 | 640° C. | 165 | 355 | 115 |
| 600° C. | 165 | 379 | 130 | | | | |

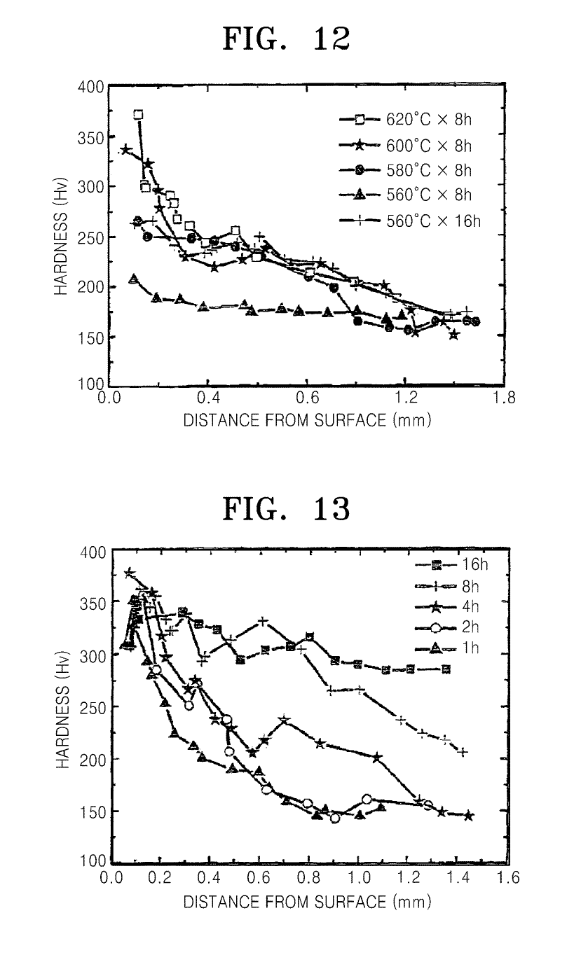

FIG. 12 shows the hardness distribution in the thickness direction of the IF steel nitrided according to embodiment V of the present invention.

The IF steel is nitrided in the KNO₃ molten salt at 560° C. for 16 hours and at temperatures of 560° C., 580° C., 600° C., and 620° C. for 8 hours.

Referring to FIG. 12, the hardness of the IF steel decreases with an increase in a depth from the surface of the IF steel because the nitrogen concentration decreases with an increase in the distance from the steel surface. When the nitrided depth is defined as the distance between the surface and the position where the hardness value is equal to 110% of that of the center of the IF steel before nitriding, the nitrided depth formed in each condition ranges from about 1.38 mm to 1.5 mm, which is 3 to 5 times thicker than the thickness of a nitrided layer formed using a conventional method.

FIG. 13 is a graph showing a hardness distribution in the thickness direction of the IF steel nitrided in the KNO₃ molten salt at 640° C. for 1 hour, 2 hours, 4 hours, 8 hours, and 16 hours.

As shown in the FIG. 13, for IF steel, as the nitriding time increases, the difference in hardness between the surface and the interior of the IF steel decreases, resulting in the IF steel having, as well as an increased surface hardness, an increased bulk hardness, as a consequence of nitrogen diffusing into the interior and a decrease in the difference between the concentrations of nitrogen on the surface and in the interior of the steel. In other words, the nitriding method according to the current embodiment of the present invention will lead to an IF steel having increased surface and bulk hardness, resulting from nitrogen diffusing into the interior of the steel at a higher diffusion rate than a conventional nitriding method.

### EMBODIMENT VI

In the current embodiment of the present invention, steel is nitrided using Ca(NO₃)₂ molten salt.

The steel to be nitrided in the current embodiment is low carbon steel.

Since Ca(NO₃)₂ is highly hygroscopic at room temperature, including combined water, it is preferable to use Ca(NO₃)₂ after removing moisture by heating Ca(NO₃)₂ for a predetermined time.

The present embodiment of the present invention includes the process of removing moisture by heating Ca(NO₃)₂ for 4 hours at 100° C. to 150° C., heating Ca(NO₃)₂ to 580° C. to form a Ca(NO₃)₂ molten salt, and submerging the low carbon steel in a bath of the Ca(NO₃)₂ molten salt (hereinafter, referred to as a Ca(NO₃)₂ molten salt bath) for 3 hours.

FIG. 14 is a graph showing the surface hardness profile in low carbon steel nitrided by the current embodiment of the present invention.

As shown in FIG. 14, the low carbon steel nitrided by the current embodiment is nitrided to a depth of 0.5 mm from the surface of the low carbon steel, and has a surface hardness that is 2 times higher than the surface hardness (see As) of the steel before nitriding.

### EMBODIMENT VII

In the current embodiment of the present invention, steel is nitrided using a molten mixture of KNO₃ and NaNO₃.

In the current embodiment of the present invention, the low carbon steel is nitrided in the molten mixture of KNO₃ and NaNO₃ of which mixture ratios are 1:1, 8:2 and 2:8.

Table 7 shows the surface hardness values of steels nitrided by the current embodiment of the present invention. Various types of steel are submerged in the molten mixture of KNO₃ and NaNO₃ with a mixture ratio of 1:1 for 12 or 24 hours at 650° C.

At this time, the hardness is measured using a Vickers hardness tester under a load of 3 kgf.

The hardness values of the steels nitrided in the mixture of KNO₃ and NaNO₃ increases by 69% to 251% depending on the steel type.

TABLE 7

| | | Change of Hardness (Hv) | | |
|---|---|---|---|---|
| Type of | Nitriding | Before nitriding | After nitriding | Increased |
| steel | Time (h) | process | process | rate (%) |
| Ultra low | 24 | 128 | 449 | 251 |
| carbon | | | | |
| steel | | | | |
| Low | 12 | 194 | 406 | 109 |
| carbon | | | | |
| steel | | | | |
| Medium | 12 | 183 | 391 | 114 |
| carbon | | | | |
| steel | | | | |
| High | 24 | 230 | 389 | 69 |
| carbon | | | | |
| steel | | | | |
| Alloy steel | 24 | 226 | 387 | 71 |

Various steels are submerged in the mixture of KNO₃ and NaNO₃ with a mixture ratio of 1:1 at 580° C., and changes in the surface hardness and tensile strength of the nitrided steels depending on nitriding time are measured.

As shown in Table 8, nitriding according to the current embodiment of the present invention increases the hardness and the tensile strength of all the steels. The hardness and tensile strength increase with increasing nitriding time.

TABLE 8

| | | | | | Change of Tensile Strength | | |
|---|---|---|---|---|---|---|---|
| | | Change of Hardness (Hv) | | | (kgf/mm²) | | |
| Type | Nitriding | Before | After | | Before | After | |
| of | Time | nitriding | nitriding | Increasing | nitriding | nitriding | Increased |
| steel | (h) | process | process | rate (%) | process | process | rate (%) |
| Ultra | 3 | 120 | 283 | 136 | 35 | 48 | 37 |
| low | 12 | 120 | 421 | 251 | 35 | 92 | 163 |
| carbon | | | | | | | |
| steel | | | | | | | |
| Low | 3 | 200 | 283 | 42 | 45 | 55 | 22 |
| carbon | 12 | 200 | 403 | 102 | 45 | 79 | 76 |
| steel | | | | | | | |
| Medium | 3 | 130 | 181 | 39 | 45 | 57 | 27 |
| carbon | 12 | 130 | 398 | 206 | 45 | 88 | 84 |
| steel | | | | | | | |
| High | 3 | 150 | 201 | 34 | 60 | 76 | 27 |
| carbon | 12 | 150 | 391 | 161 | 60 | 87 | 45 |
| steel | | | | | | | |
| Alloy | 3 | 200 | 274 | 37 | 55 | 75 | 36 |
| steel | 12 | 200 | 409 | 105 | 55 | 90 | 64 |

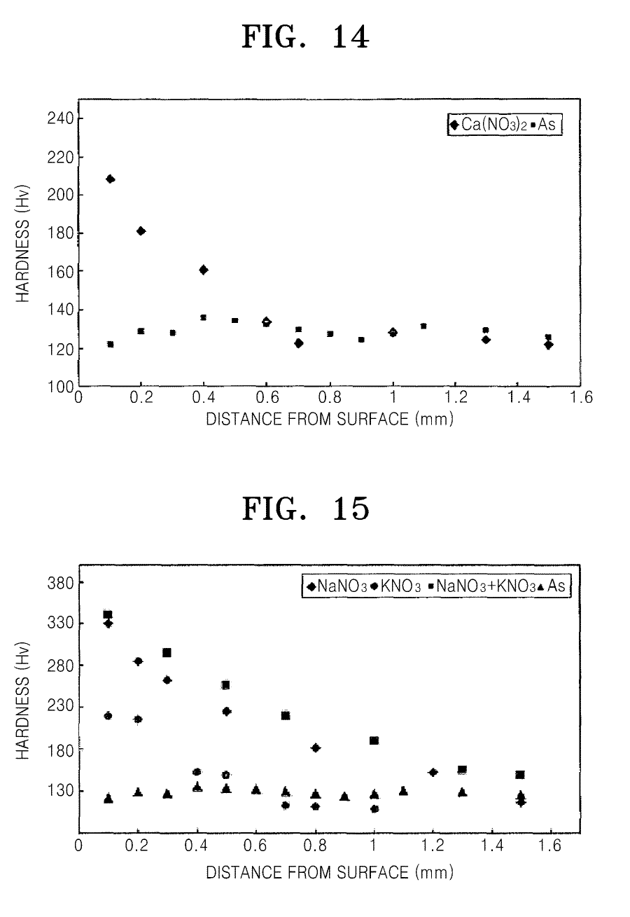

FIG. 15 is a graph showing the hardness profiles of steel nitrided at 680° C. for 200 minutes in a KNO₃ bath, a NaNO₃ bath, and a 50% KNO₃-50% NaNO₃ mixture bath at 680° C. for 200 minutes.

The hardness was measured using a Vickers hardness tester.

In FIG. 15, the steel nitrided in the mixture bath has a nitrided depth of 1.5 mm and a surface hardness of 160 Hv, which are higher than those of the steel nitrided in the single salt baths and 3 times higher than those of the steel before nitriding.

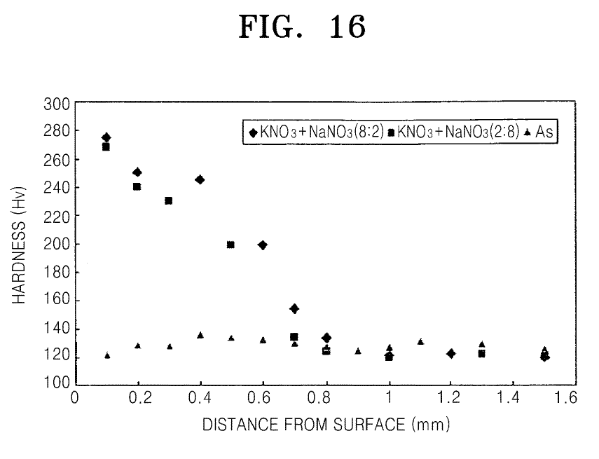

FIG. 16 is a graph showing the hardness profiles of the low carbon steel nitrided in the 80% KNO₃-20% NaN₃ mixture bath and 20% KNO₃-80% NaNO₃ mixture bath at 650° C. for 4 hours, respectively.

As shown in FIG. 16, the surface hardness of the steel nitrided in these mixture baths is about 2 times higher than that of the steel before nitriding.

The present invention can solve an environmental pollution problem and can reduce a cost for nitriding steels by using molten non-cyanide salts, such as sodium nitrate (NaNO₃), sodium nitrite (NaNO₂), calcium nitrate (Ca(NO₃)₂), and their mixtures.

Since the present invention can increase the nitrided depth or nitrogen-diffusion depth of a steel to two to six times higher than that obtained using conventional nitriding methods, thereby nitriding the inner part of the steel as well as the surface of the steel, its applications can be extended to various fields.

Since the present invention can be applied to bulk hardening as well as surface hardening of steels by increasing the hardness and tensile strength of the steel, it is possible to apply the present invention to many fields including light and highly-durable automobile components and diverse structural members which require improved wear resistance, corrosion resistance, and fatigue life.

The present application contains subject matter related to Korean patent application No. 2006-0049077, filed in the Korean Intellectual Property Office on May 30, 2006, the entire contents of which are incorporated herein by reference.

The terms and words used in the present specification and claims should not be construed to be limited to the common or dictionary meaning, because an inventor defines the concept of the terms appropriately to describe his/her invention as best he/she can. Therefore, they should be construed as a meaning and concept fit to the technological concept and scope of the present invention.

Therefore, the embodiments and structure described in the present specification are nothing but one exemplary embodiment of the present invention, and do not represent all of the technological concepts and scope of the present invention. Therefore, it should be understood that many equivalents and modified embodiments that can substitute those described in this specification exist.

What is claimed is:

1. A steel comprising:
a first layer comprising an ultra-low carbon steel; and
a second layer contacting with the first layer, comprising a first surface opposite to the first layer, comprising a solid solution obtained by solid-solving nitrogen in the ultra-low carbon steel, and having a structure substantially the same as a structure of the first layer.

2. The steel of claim 1, wherein an iron-nitrogen compound is neither comprised in the first surface of the second layer nor in an area adjacent to the first surface of the second layer.

3. The steel of claim 2, further comprising a third layer that is formed on the second layer so as to prevent corrosion of the first surface, and comprises a second surface that contacts the first surface.

4. The steel of claim 1, further comprising a fourth layer that is formed on the second layer, comprises a third surface that contacts the first surface, and comprises an iron-nitrogen compound.

5. The steel of claim 4, wherein the iron-nitrogen compound is comprised in the first surface of the second layer or in an area adjacent to the first surface of the second layer.

6. The steel of any of claims 1 through 5, wherein the ultra-low carbon steel comprises no more than 0.01 wt % (not comprising 0 wt %) carbon.

7. A steel comprising:
a base metal comprising steel that comprises no more than 0.01 wt % (not including 0 wt %) carbon, and comprising a surface; and
a solid solution layer formed in an interior part of the base metal to be distant from the surface of the base metal, obtained by solid-solving nitrogen at an interstitial site of the base metal, and having a structure substantially the same as a structure of the base metal.

8. The steel of claim 7, wherein an iron-nitrogen compound is neither comprised in the surface of the solid solution layer nor in an area adjacent to the surface of the solid solution layer.

9. The steel of claim 8, further comprising a first coating that is formed on and in contact with the surface of the solid solution layer so as to prevent corrosion of the solid solution layer.

10. The steel of claim 7, further comprising a second coating that is formed on and in contact with the surface of the solid solution layer and comprises an iron-nitrogen compound.

11. The steel of claim 10, wherein the iron-nitrogen compound is formed on the surface of the solid solution layer or formed in an area adjacent to the surface of the solid solution layer.
